(19) United States
(12) Patent Application Publication
(10) Pub. No.: US 2011/0289115 A1
(43) Pub. Date: Nov. 24, 2011

(54) SCIENTIFIC DEFINITIONS TOOL

(75) Inventors: Martin Roy Schiller, Henderson, NV (US); Patrick Gradie, Henderson, NV (US)

(73) Assignee: Board of Regents of the Nevada System of Higher Education on Behalf of the University of Nevada, Las Vegas, NV (US)

(21) Appl. No.: 13/112,746

(22) Filed: May 20, 2011

Related U.S. Application Data
(60) Provisional application No. 61/395,965, filed on May 20, 2010.

(51) Int. Cl. G06F 17/30

(52) U.S. Cl. 707/770; 707/769; 707/E17.032; 707/E17.014

(57) ABSTRACT

A method and apparatus provide definition information to a reader during reading of a text within a defined field of technology or literature. This can be done, for example, by:
a) a user accesses a text in memory and displays at least a portion of the text on a display;
b) the user identifying a specific word in the text for which further information is sought;
c) the user communication to a processor that further information is sought on that specific word;
d) the processor accessing a system database (internal or external to the system, single sources or multiple sources) having information relating to the defined field of technology or literature;
e) the database responding to the accessing seeking further information comprising that specific word by providing file content from within the database containing that specific word,
f) file content is provided containing uses of that specific word in a format of that specific word in combination with all single preceding word and each single subsequent word combinations of that specific word;
g) the provided word content being in the form of a definition data structure that is immediately readable or can be opened by the reader.

### RELATED APPLICATION DATA

The present Application claims priority from U.S. Provisional Patent Application 61/395,965, filed May 20, 2010.

### BACKGROUND OF THE INVENTION

1. Field of the Invention

The disclosed technology herein relates to the field of user assistance in the review or reading of documents and particularly to the provision of definitions for terms or words to a reader. The technology herein is particularly useful in the fields of sciences where words and terms have more standardized meanings.

2. Background of the Art

One issue that often makes reading of sophisticated or complex material, and especially technical literature difficult to read is the appearance of unfamiliar words or terms that disrupt the flow and comprehension of the text. It greatly slows down the reading process to access a physical dictionary, go on line to a distinct site for definitions, or even use an embedded dictionary. It is desirable to develop systems that enable access to definitions of individual words or terms during reading of texts that minimizes interruption of the reading process.

U.S. Pat. No. 7,636,713 (Jadhav) describes a search engine that finds and ranks information in clusters so a user can select information listed in search results that are closer to his information needs. To do so, the search engine receives a proximity query and executes it against an entity-relationship graph. The search engine finds those entities in the graph that have similar relationships between nodes. For example, two entities in a graph may be connected to entirely different nodes, but they may connect to those different nodes using similarly labeled paths. The search engine identifies the relationship between the nodes, clusters entities that are connected by similar relationships, and presents the clustered information to the user as part of the search results. In this way, the search engine provides a user with a results from which the user can select the group of results that most closely match his information need.

U.S. Pat. No. 7,634,500 (Raj) describes a method and apparatus for multiple string searching using a ternary content addressable memory. For one embodiment, the method includes receiving a text string having a plurality of characters and performing an unanchored search of a database of a stored patterns matching one or more characters of the text string using a state machine, wherein the state machine comprises a ternary content addressable memory (CAM) and wherein the performing comprises comparing a state and one of the plurality of characters with contents of a state field and a character field, respectively, stored in the ternary CAM. In various embodiments, one or more of the following search features may be supported: exact string matching, inexact string matching, single character wildcard matching, multiple character wildcard matching, case insensitive matching, parallel matching and rollback.

U.S. Pat. No. 7,584,216 (Travieso) and U.S. Pat. No. 7,580,960 (Travieso) describes a method for providing translations of texts, which translated texts may be incorporated into a unified dictionary according to practices within the present technology. By providing translated texts, the underlying database in dictionaries used in the practice of the present invention can be expanded.

Published US Application Documents Nos. 20060075345 and 20090106206 (Sherman) describe internal reference systems that provide transport within a document to definitions of terms, or access to a file associated with a text that provides definitions or information of terms according to reader status or state at different positions within the text.

### SUMMARY OF THE INVENTION

A method and apparatus provide definition information to a reader during reading of a text within a defined field of technology or literature. This can be done, for example, by:
a) a user, the person who is reading a document and accessing the present technology, accesses a text in memory and displays at least a portion of the text on a display;
b) the user identifying a specific word in the text for which further information is sought;
c) the user communication to a processor that further information is sought on that specific word;
d) the processor accessing a system database (internal or external to the system, single sources or multiple sources) having information relating to the defined field of technology or literature;
e) the database responding to the accessing seeking further information comprising that specific word by providing file content from within the database containing that specific word,
f) file content is provided containing uses of that specific word in a format of that specific word in combination with all single preceding word and each single subsequent word combinations of that specific word; and
   the provided word being returned in a format that is recognizable by the reader. For example, the database will create a data structure in memory containing a list of words and their associated definitions. (each word will be paired with its definitions and multiple word phrases may be returned).

An alternative description of a related process may be provided as:

a) A user puts a document into the client application's memory and the client application displays a portion of that document to the user on the screen;

b) The user identifies a specific word in the text displayed by the client application that they want to know the definition for (this can be done by clicking, hovering, etc.);

c) The client application communicates with the web server that further information is requested about a specific word;

d) The web server communicates with a system database (internal or external to the system and in either a single or multiple source) to retrieve information relating to the requested word;

e) The database returns information related to the word requested;

f) The server then returns the requested information back to the client application in a format that the client application can read; and

g) The client application displays the relevant information to the user in an easy to read format.

### BRIEF DESCRIPTION OF THE FIGURES

FIG. 1 shows a schematic of an example of a system useful in the practice of the technology described herein.

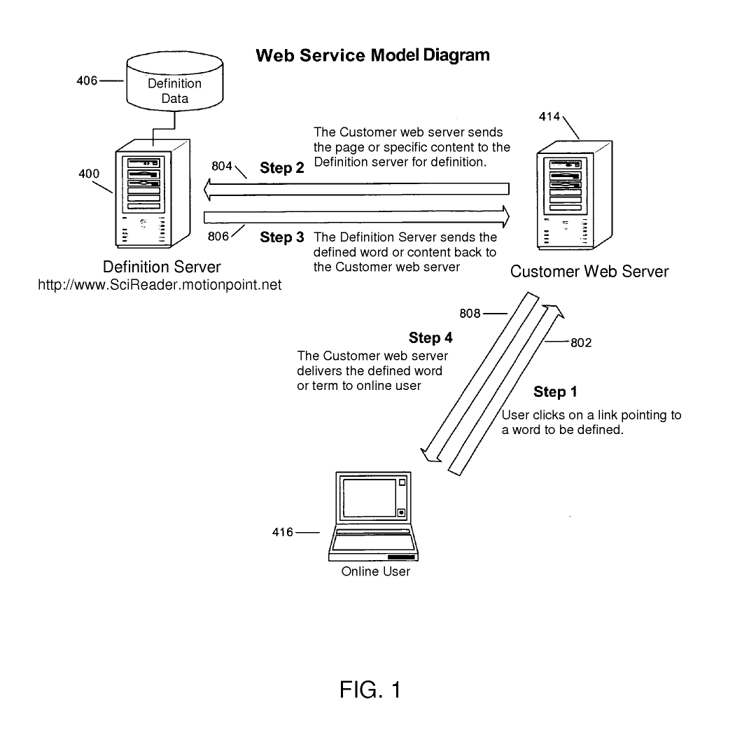

### DETAILED DESCRIPTION OF THE INVENTION

The technology described herein may, at different times, be referred to as the SciReader™ system, which is one embodiment of the present technology. The SciReader™ system is not the exclusive possible embodiment of this technology within the scope of the disclosure and claims, but represents a completed system that can be discussed extensively. By referencing that specific system in the discussion, it is not the intent of the inventors to exclude variations or limit the scope of the generic nature of the present invention.

The present technology may be generally described as a method of providing definition information to a reader during reading of a text within a defined field of technology or literature. (e.g., the database will create a data structure in memory containing a list of words and their associated definitions. (Each word will be paired with its definitions and multiple word phrases may be returned). The defined field may be general (e.g., English language or Science or may be more specific, such as cellular biology, AIDS, Postural Orthostatic Tachycardia Syndrome).

The method may have steps such as:
a) a user accesses a text in memory and displays at least a portion of the text on a display;
b) the user identifying a specific word in the text for which further information is sought;
c) the user communication to a processor that further information is sought on that specific word;
d) the processor simultaneously accessing multiple databases having information relating to the defined field of technology or literature;
e) each of the multiple databases responding to the accessing seeking further information on that specific word by providing file content from within the database containing that specific word,
f) file content is provided containing uses of that specific word in a format comprising that specific word in combination with all single preceding word and each single subsequent word combinations of that specific word;
   the provided word content being in the form of a file identifier that can be opened by the reader. The database will create a data structure in memory containing a list of words and their associated definitions. (each word will be paired with its definitions and multiple word phrases may be returned).

An alternative aspect of the invention may include a system enabling provision of definition information to a reader during reading of a text within a defined field of technology or literature comprising:
a) a user input system configured to allow input of search parameters;
b) a user visual output system;
c) the user input system in communication connectivity with a processor;
d) the processor in communication interconnectivity with a text in memory;
e) search input from the user input being transmitted to the processor and causing displays of at least a portion of the text on a display in the user visual output system;
   the processor and memory and display configured such that upon the user identifying a specific word in the text for which further information is sought, communication of that identified specific word in the text to the processor commands a search for further information to be sought on that specific word, such that during that search, the processor simultaneously accesses multiple databases having information relating to the defined field of technology or literature, and each of the multiple databases responds to the accessing seeking further information on that specific word by providing file content from within the database containing that specific word, wherein file content is provided and visually displayed on the display containing uses of that specific word in a format comprising that specific word in combination with all single preceding word and each single subsequent word combinations of that specific word; and the provided word content is in the form of definition data structure that can be opened by the user through the user input.

1) Definitions for words in any document you want to read.

2) Display of said words as part of the document you are reading thus eliminating the need to focus attention off of the current page. Instead of opening up a separate window, opening up a web browser, or opening up a physical dictionary, all words are displayed to the user with minimal user interaction

3) The ability to obtain the definition of word phrases with minimal effort. Namely, the ability to click on, or hover over, a single word and obtain the definition of the word phrase it belongs to in the sentence. (e.g. The definition for: “Secretary of the Interior” could be looked up simply by clicking on any of the 4 words that make up the phrase).

In performing these steps, the following considerations may be made:
1) Definitions may be generally provided for words in any document a user wants to read. (Specific attempts to do this have been considered elsewhere but the present technology seeks to make this a more comprehensive collection of many available original sources. But a perfect collection of all definitions and information at a moment in time is not something that can really be accomplished since worldwide databases will never be complete either)
2) Display of said words as part of the document being read, thus eliminating the need to focus attention off of the current page. Instead of opening up a separate window, opening up a web browser, or opening up a physical dictionary, all words are displayed to the user with minimal user interaction.
3) The ability to obtain the definition of word phrases with minimal effort. Namely, the ability to click on, or hover over, a single word and obtain the definition of the word phrase it belongs to in the sentence. (e.g. The definition for: “Secretary of the Interior” could be looked up simply by clicking on any of the 4 words that make up the phrase).
2) and 3) really assist in advancing the present technology beyond any known reading application. Both are very desirable capabilities to have in such an application.

The defined term with definition or a file identifier may be a display of at least an image or icon of the specific word in a format of that specific word in combination with all single preceding word and each single subsequent word combinations of that specific word. This can be done as: 1) The user selects a word for definition within the display of the client application; 2) The client application sends that word along with a section of text surrounding that word to the web server; and 3) The web server then retrieves definitions from the system database for the selected word as well as any recognized word phrases containing that word found within the selection of text sent from the client application. This selection of text may, for example, be the sentence that the selected word belongs to.

The file identifier may be a display of at least an image or icon of the specific word in a format of that specific word in combination with all single preceding word and each single subsequent word combinations of that specific word and a description of the specific database from which the further information is being provided. The defined field of technology is preferably selected from the group consisting of scientific domains, such as biology, chemistry, physics and medicine, but may be any scientific or engineering field.

An alternative description of a process within the scope of this technology is a method of providing definition information to a reader during reading of a text within a defined field of technology or literature. The method may include steps such as:
a) a user accesses a text in memory and displays at least a portion of the text on a display;
b) the user identifying a specific word in the text for which further information is sought;
c) the user communication to a processor that further information is sought on that specific word;
d) the processor accessing a system database having information relating to the defined field of technology or literature;
e) the database responding to the accessing seeking further information comprising that specific word by providing file content from within the database containing that specific word,
f) file content is provided containing uses of that specific word in a format of that specific word in combination with all single preceding word and each single subsequent word combinations of that specific word;
g) the provided word content being in the form of a file identifier that can be opened by the reader.

Results may be displayed on the screen or printed out. During review of a particular text, past reviewed definitions may be stored in a short-list pull-up file. The database may also be constructed by accessing or federating multiple established dictionaries and federating them into one source dictionary as the database. The database, for example, may be federated from at least some multiple established dictionaries by parsing individual dictionaries originally in different formats and converting the different formats into a single format for the database. Alternatively, the database is federated from at least some multiple established dictionaries by parsing individual dictionaries originally in different formats and a parsing program is provided to search each dictionary in its native format and then providing the word and associated information to the database. The reader may view the text in one portion of the display screen and the processor provides multiple definition data structures, which may be simple data structures of information passed from the web server to the client application (sometimes referred to herein as files or even file identifiers) of the available definitions for the specific word at the same time in a defined area of the display screen that does not entirely hide any or all of the displayed text. A “definition data structure” is the data content of a definition provided from the web server to the user in this application. Alternatively, the reader views the text in one portion of the display screen and the processor provides multiple file identifiers of the available definitions for the specific word at the same time in a defined area of the display screen that does not entirely hide and or all of the displayed text. The defined area may be a dedicated portion of the display screen along either the top edge of the display screen or along the bottom edge of the display screen, or the defined area is a dedicated portion of the display screen along either a left edge of the display screen or along a right edge of the display screen. One additional aspect of the present technology is the ability to provide a neural network on the system to rank definitions or sources according to defined criteria (e.g., a) most recent publication, b) an order of respected authority according to a predetermined list, such as 1) JAMA, 2) NEJM, 3) Nature, 4) Random House Dictionary . . . 20) Wikepedia, etc., c) named authors; and the like). The neural network may also rank definitions according to context (e.g., term is in Title, term is in Abstract, term is in bibliography, etc.).

SciReader™ System

This disclosure contains relevant information on how the SciReader™ system and its application works.

1 Database

The SciReader™ system dictionary database may, for example, comprise at least two main electronic tables. These two electronic tables stored in memory would contain all of the words in the database along with definitions, part of speech, and other information relevant to retrieval and presentation of the operation of the SciReader™ system. The database is implemented in MySQL.

1.1 Index Table

The first table comprises three columns: A word identification column (“wordID”), a word phrase column (“word”), and a word length column (“length”). The word identification column is made up of a unique number that identifies the word in the same row. The word phrase column is filled with a unique list of every word found in the database. This column is indexed in MySQL due to the fact that unique columns provide efficient searches when indexed. For each word in the word phrase column, there is an entry in the word length column which is determined by the number of words in the word phrase column. It is important to note that this database delimits words on any character that is not alphabetic. For this reason spaces, hyphens, etc. will count as words in determining the length of a phrase. For example, the row containing the word phrase “Cell membrane” will have a word length value of 3 and the word phrase “used-car dealer” would be 5. To speed up runtime processing time, the length of every word in the index column is preprocessed.

1.2 Definition Table

The second table consists of a word identification column followed a definition, part of speech (“pos”), source, word phrase, domain, tag count, example, and definition identification column. The word identification column is not unique like it is in the Index Table. This is due to the fact that one word phrase can have many definitions. For example, the word “run” will be given a specific word identification number (3614 in the database). However, since the word “run” has multiple definitions in the definition table, each one of those definitions will be given the same word identification number so that they can be found when the database tries to return the definitions of run. The definition column will contain a specific definition for the word that its word identification number points to. The part of speech column will contain the specific part of speech that this definition refers to. This is required because some words may belong to different parts of speech. For example, the word “run” could be defined as a noun or a verb. The source column contains the dictionary source of the definition. For example, many of our English words are pulled from the WordNet 3.0 database whereas a number of our Biological definitions are pulled from the Medical Subject Headings database. The word phrase column contains the word that is being defined. It is placed in this database for convenience. The length column is a redundant copy of the length column in the Index Table. The domain column contains an enumerated value representing the domain of the definition. The domain of a definition can be defined as either the field of study the definition can be found in or what type of word the definition is referring to. For example, a definition of the word “orange” may belong to the domain “fruit” whereas the word laser may belong to the domain “physics.” This column will help us in the future to deliver more accurate definitions or rank order definitions to the user. The tag count column is brought in from the WordNet 3.0 database and it contains information regarding the relevance of a definition. The higher the number in this column is, the more frequently a definition is found to be relevant in writing. The example column will contain, if available, a sample sentence of the defined word used in the context it is being defined in. Finally, the definition identification column contains a unique number identifying each definition. It is not expected to be used but is included for completeness.

1.3 Database Construction

The database is constructed by taking multiple established dictionaries and federating them into one source dictionary. Due to the fact that every external database is constructed with a unique format, a program must be created for each one to import the data into the SciReader database. These programs parse the data found in the external database into the format of the SciReader database. As time goes on, it is likely that the various external databases would be enhanced or added to. Therefore, the database for SciReader would regularly be updated by taking the most up to date external sources and reconstructing the SciReader database. There is also a method by which we can generate standardized definitions for gene names, protein names, etc. This is based on using various databases (NCBI Entrez gene, PIR, Gene Ontology, and others to put text into a standard syntax. This is important because we can define many gene and protein names that do not have definitions.

2 Front End

The front end of this SciReader™ system application is kept simple but the actual format, design, and functionality is under optimization development and may change in the future to add more features.

2.1 Search Bar

There is a small window at the top of the application that allows a user to input a single word. The word is sent to the server and a list of definitions is returned (if the word is found in the database).

2.2 Word Info Area

This area is made up of two major sections, a tab area and a definition area.

2.2.1 Tab Area

Each word that is returned from the server is given a unique tab. If a user clicks on a tab they are given a list of definitions for the word in the definition area below. The last word searched is presented in the active tab and, if identified, a compound word is put in the active tab, rather than the single word that is searched for.

2.2.2 Definition Area

This area contains the definitions of the word given within its tab. The format of a definition is as follows:

[source] part of speech. Definition [“example sentence”]

Different ways of ranking definitions are under development and there are commercially available ranking or hierarchal systems available that can be used in this format. Also, it is worthy of note that clicking on a word in this area will initiate a search on whatever word was clicked. This area will also contain hyperlinks to external information (e.g.) a wikipedia page) when implemented.

2.3 Reading Area

This area contains the uploaded reading material. Currently this is displayed as either plain text or a simple HTML markup. If a user clicks on a word within the reading area, they will be given the definition of that word (and associated word phrases) in the Word Info Area. This display area may be variously located on the screen display.

2.4 Text Input Area

This area allows the user to upload material into the reading area. Currently, the only supported formats are plain text and simple HTML. However, in the future we will allow users to upload PDF files, Office files, etc.

3 Word Search

When a user clicks on a word from either the Reading Area or Word Info Area or enters a word into the search bar, a word search is initiated.

3.1 Reading Area/Word Info Area Search

A word search is carried out in the following manner when initiated from the Reading Area or Word Info Area:
1. The selected word (preferably as well as the entire sentence or a substantive sentence fragment [such as at least 4 words, at least 5 words, etc.] to which the selected word belongs to) is sent to the server. The word plus the additional content is referred to herein as the “word context.” The word plus at least one of the word and an immediately preceding word and/or an immediately following word are referred to herein as the “word phrase.”
2. The server uses the selected word and/or word context as a well as the words directly to the left and right of the word (i.e., the word phrase) to do a search in the index table. The point of this step is to find all possible word phrases in the database that contain the selected word. To greatly trim the returned set, the words to the left and right of the selected word are used, either one-at-a-time or both at the same time (creating a three-word phrase). For example, if the selected word was “of” the database would return hundreds of phrases containing that word. However, if the word next to “of” in the sentence was “course” the search would return only those containing “of course” which is a much smaller set. Certain words may also be automatically excluded from the word phrases as insignificant, such as prepositions, definite articles, indefinite articles, pronouns and the like.
3. Using the largest length of all returned word phrases, the user's sentence is searched for all of the word phrases returned from step 2. This is necessary because there are almost always many results from step 2 that are not found in the sentence passed through from the client.
4. Any matches that are found from step 3 will have their definitions looked up and are sent back to the client.
5. The client receives a list of word phrases and definitions from the server and creates a tab for each word phrase in the Word Info area. Each tab is filled with all corresponding definitions upon creation. The user is then free to read the definition of the selected word as well as word phrases that are both made up of that selected word and contained within the sentence of the selected word.

This process gives the user access to functionality not found in other similar programs. The main advantage to using SciReader over other reading environments is the speed and ease of definition searching. By returning both the selected word and related word phrases to the client application, the user does not have to do any additional work to find the definition of a compound word phrase than click on one of its containing words. For example, consider the sentence, “The cell membrane plays host to a large amount of protein that is responsible for its various activities.” (Wikipedia) If the user wants to find the definition of “cell membrane” they can retrieve it by clicking on either “cell” or “membrane.” As a bonus they will receive the word they clicked on in case they would like to see what that word means alone. This feature, as well as the in a frame or fixed-frame definition box style of the Word Info area, reduces the time spent looking up words.

3.2 Single Search

This search is quite simple. The entered word is passed to the server and any definitions are passed back. It does not look for word phrases, but will return a compound word definition if it exists in the data base, as by typing in “cell base” to get the proper complete term definition.

4 Use Cases

The way a user actually uses this application is exemplified above in a non-limiting manner. The following is a walkthrough of a how someone would use the SciReader™ system application.

Joe Smith wants to read an article he found on a topic in Biology. He unfortunately does not know a whole lot about Biology so he knows he will need to look up a lot of the words in the article. He decides to pull up the SciReader™ system to make it a little easier. When the application loads s/he logs in the user name and begins. He copies the text from the article into the Text Input Area and clicks “Input Text.” The Reading Area is then populated with the text from the article. S/He begins reading and doesn't understand one of the words. It is a 3-word phrase so he just clicks on one of the words. The word he clicked on comes up into the Word Info area as well as the 3-word phrase. S/He wanted to know what the 3-word phrase was so s/he reads it since it was selected. S/He now knows what that phrase meant and continues reading. He pulls up a few more definitions and comes across that phrase from before. He just clicks it again and the tab switches back to the same definition phrase and s/he gets a quick refresher. As s/he is reading a word pops into the user's head. The word isn't in the Reading Area, but s/he would still like to know its meaning so s/he types it into the Search Bar and gets a definition for it. As s/he reads further, s/he does a search on a word. While reading the definition there is a word within the definition that s/he doesn't understand. S/He clicks that word and a new tab shows its definition. After reading that definition, s/he clicks on the previous tab and finishes reading the definition at hand. This process continues until the article is finished.

The present technology may be implemented on existing apparatus with appropriate software embedded therein and appropriate communication links between internal and external memories, hardware, servers, processors and the like. The system will use machine readable medium in providing the files. The term “machine-readable medium” as used herein refers to any medium that participates in providing data that causes a machine to operation in a specific fashion. In an embodiment implemented using computer system 300, various machine-readable media are involved, for example, in providing instructions to processor 304 for execution. Such a medium may take many forms, including but not limited to, non-volatile media, volatile media, and transmission media. Non-volatile media includes, for example, optical or magnetic disks, such as storage device 310. Volatile media includes dynamic memory, such as main memory 306. Transmission media includes coaxial cables, copper wire and fiber optics, including the wires that comprise bus 302. Transmission media can also take the form of acoustic or light waves, such as those generated during radio-wave and infra-red data communications.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 304 for execution. For example, the instructions may initially be carried on a magnetic disk of a remote computer. The remote computer can load the instructions into its dynamic memory and send the instructions over a telephone line using a modem. A modem local to computer system 300 can receive the data on the telephone line and use an infra-red transmitter to convert the data to an infra-red signal. An infra-red detector can receive the data carried in the infra-red signal and appropriate circuitry can place the data on bus 302. Bus 302 carries the data to main memory 306, from which processor 304 retrieves and executes the instructions. The instructions received by main memory 306 may optionally be stored on storage device 310 either before or after execution by processor 304.

Computer system 300 also includes a communication interface 318 coupled to bus 302. Communication interface 318 provides a two-way data communication coupling to a network link 320 that is connected to a local network 322. For example, communication interface 318 may be an integrated services digital network (ISDN) card or a modem to provide a data communication connection to a corresponding type of telephone line. As another example, communication interface 318 may be a local area network (LAN) card to provide a data communication connection to a compatible LAN. Wireless links may also be implemented. In any such implementation, communication interface 318 sends and receives electrical, electromagnetic or optical signals that carry digital data streams representing various types of information.

Network link 320 typically provides data communication through one or more networks to other data devices. For example, network link 320 may provide a connection through local network 322 to a host computer 324 or to data equipment operated by an Internet Service Provider (ISP) 326. ISP 326 in turn provides data communication services through the world wide packet data communication network now commonly referred to as the “Internet” 328. Local network 322 and Internet 328 both use electrical, electromagnetic or optical signals that carry digital data streams.

The signals through the various networks and the signals on network link 320 and through communication interface 318, which carry the digital data to and from computer system 300, are exemplary forms of carrier waves transporting the information.

Computer system 300 can send messages and receive data, including program code, through the network(s), network link 320 and communication interface 318. In the Internet example, a server 330 might transmit a requested code for an application program through Internet 328, ISP 326, local network 322 and communication interface 318.

The practice of the present technology may also incorporate other features, particularly those available in the existing art. For example, as disclosed in U.S. Pat. No. 7,672,927 (Borkovsky et al.), a method and apparatus for generating a list of candidate alternative spellings may be provided. Among a plurality of files, a first file, which contains a link that indicates a user-entered spelling, is found. The link links to a second file. A second spelling, which is spelled similarly to, but not exactly the same as, the first spelling, is located within the second file. The second spelling is added to a list of candidate alternative spellings of the first spelling. The second spelling does not need to be contained in any result field (e.g., title, abstract, or URL) that is associated with the second file.

It is to be appreciated that technology described herein can include software that acts as an intermediary between users and the basic computer resources described in the suitable operating environments. Such software includes an operating system, which can be stored on disk storage, acts to control and allocate resources of the computer system. System applications take advantage of the management of resources by operating system through program modules and program data stored either in system memory or on accessible storage such as disk storage. It is to be appreciated that the claimed subject matter can be implemented with various operating systems or combinations of operating systems.

A user enters commands or information into the computer through input device(s). Input devices include, but are not limited to, a pointing device such as a mouse, trackball, stylus, touch pad, keyboard, microphone, joystick, game pad, satellite dish, scanner, TV tuner card, digital camera, digital video camera, web camera, touchscreens and the like. These and other input devices connect to the processing unit through the system bus via interface port(s). Interface port(s) include, for example, a serial port, a parallel port, a game port, and a universal serial bus (USB). Output device(s) use some of the same type of ports as input device(s). Thus, for example, a USB port may be used to provide input to computer, and to output information from computer to an output device. Output adapter is provided to illustrate that there are some output devices like monitors, speakers, and printers, among other output devices, which require special adapters. The output adapters include, by way of illustration and not limitation, video and sound cards that provide a means of connection between the output device and the system bus. It should be noted that other devices and/or systems of devices provide both input and output capabilities such as remote computer(s).

A Computer can operate in a networked environment using logical connections to one or more remote computers, such as remote computer(s). The remote computer(s) can be a personal computer, a server, a router, a network PC, a workstation, a microprocessor based appliance, a peer device or other common network node and the like, and typically includes many or all of the elements described relative to the user's computer. For purposes of brevity, only a memory storage device is mentioned with remote computer(s). Remote computer(s) is logically connected to the user's computer through a network interface and then physically connected via communication connection. Network interface encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

In the practice of this technology, the information is provided to the user as an image on the display, either in a column adjacent the text, a box adjacent the text, a picture-in-picture provision, a balloon over the text, or in any other format on the same screen as the user has to view the text. It is possible with present sophistication in equipment to have multiple screens on a single device, so that definitions and references can be provided on a minor screen attached to the same device as the major reading screen, or even having a separate device (e.g., cell phone, iPhone, PDA, Blackberry, etc.) directly (by wire or cable) or indirectly (WiFi, etc.) associate with a main reader, with the definitions provided on the separate screen. That would be a less preferred embodiment.

In providing the displayed definitions, it must be remembered that the process causes an at least temporary transformation of the display screen. Most display screens are actually digital in nature, with LEDs, semiconductor elements, liquid crystals, phosphors and other distinct light-emitting components provided across the viewing surface. In providing the image, image data is electronically sent to the imaging system, and the imaging system causes localized transient (or in the case of printing, permanent) transformations in chemistry, crystalinity, electronic state, electrical state, radiation transmission, radiation absorption, radiation emission and the like. Therefore, in the practice of this technology, the definition data that is transmitted to the display screen causes a local transformation of matter and the electromagnetic spectrum to cause display of the definition in the practice of the present technology.

All references cited herein are incorporated in their entirety for all information described therein.

1. A method of providing definition information to a reader during reading of a text within a defined field of technology or literature comprising:
a) a user accesses a text in memory and displays at least a portion of the text on a display;
b) the user identifying a specific word in the text for which further information is sought;
c) the user communication to a processor that further information is sought on that specific word;
d) the processor simultaneously accessing multiple databases having information relating to the defined field of technology or literature;
e) each of the multiple databases responding to the accessing seeking further information on that specific word by providing file content from within the database containing that specific word,
f) file content is provided and visually displayed on the display containing uses of that specific word in a format comprising that specific word in combination with all single preceding word and each single subsequent word combinations of that specific word; and
g) the provided word content being in the form of definition data structure that can be opened by the reader.

2. The method of claim 1 wherein the file identifier is a display of at least an image or icon of the specific word in a format of that specific word in combination with all single preceding word and each single subsequent word combinations of that specific word.

3. The method of claim 1 wherein the file identifier is a display of at least an image or icon of the specific word in a format of that specific word in combination with all single preceding word and each single subsequent word combinations of that specific word and a description of the specific database from which the further information is being provided.

4. The method of claim 1 wherein the defined field of technology is selected from the group consisting of biology, chemistry and medicine.

5. A method of providing definition information to a reader during reading of a text within a defined field of technology or literature comprising:
a) a user accesses a text in memory and displays at least a portion of the text on a display;
b) the user identifying a specific word in the text for which further information is sought;
c) the user communicates to a processor that further information is sought on that specific word;
d) the processor accessing a system database having information relating to the defined field of technology or literature;
e) the database responding to the accessing by the processor seeking further information comprising that specific word by providing file content from within the database containing that specific word,
f) file content is provided containing uses of that specific word in a format of that specific word in combination with all single preceding word and each single subsequent word combinations of that specific word; and
g) the provided word content being in the form of a definition data structure that can be opened by the reader.

6) The method of claim 5 wherein the database is constructed federating multiple established dictionaries and federating them into one source dictionary as the database.

7) The method of claim 6 wherein the database is federated from at least some multiple established dictionaries by parsing individual dictionaries originally in different formats and converting the different formats into a single format for the database.

8) The method of claim 6 wherein the database is federated from at least some multiple established dictionaries by parsing individual dictionaries originally in different formats and a parsing program is provided to search each dictionary in its native format and then providing the word and associated information to the database.

9) The method of claim 1 wherein the reader views the text in one portion of the display screen and the processor provides multiple file identifiers of the available definitions for the specific word at the same time in a defined area of the display screen that does not entirely hide all of the displayed text.

10) The method of claim 6 wherein the reader views the text in one portion of the display screen and the processor provides multiple file identifiers of the available definitions for the specific word at the same time in a defined area of the display screen that does not entirely hide all of the displayed text.

11) The method of claim 9 wherein the defined area is a dedicated portion of the display screen along either the top edge of the display screen or along the bottom edge of the display screen.

12) The method of claim 10 wherein the defined area is a dedicated portion of the display screen along either the top edge of the display screen or along the bottom edge of the display screen.

13) The method of claim 9 wherein the defined area is a dedicated portion of the display screen along either a left edge of the display screen or along a right edge of the display screen.

14) The method of claim 10 wherein the defined area is a dedicated portion of the display screen along either a left edge of the display screen or along a right edge of the display screen.

15) A method of providing definition information to a reader during reading of an electronically provided text as an image on a display screen, the text having materiality within a defined field of technology or literature comprising:
a) a user accessing on a processor the text in memory and displaying at least a portion of the text on a display;
b) the user contemporaneous running a dictionary program on the processor relating to the defined field of technology or literature;
c) the user identifying to the processor a specific word in the text for which further information is sought;
d) the user identification to the processor effecting a command to the processor that further information is sought on that specific word from the dictionary program;
e) the processor displaying multiple definition data structures from the dictionary program relating to the defined field of technology or literature;
f) the multiple definition data structures displayed comprises individual definitions from the dictionary program using comprising that specific word in a format of that specific word alone, that specific word in combination with all single preceding words and that specific word in combination with each single subsequent word.

16. The method of claim 15 wherein the individual definitions are first provided as identified definition data structures that can be opened by the reader.

17. A system enabling provision of definition information to a reader during reading of a text within a defined field of technology or literature comprising:
f) a user input system configured to allow input of search parameters;
g) a user visual output system;
h) the user input system in communication connectivity with a processor;
i) the processor in communication interconnectivity with a text in memory;
j) search input from the user input being transmitted to the processor and causing displays of at least a portion of the text on a display in the user visual output system;
the processor and memory and display configured such that upon the user identifying a specific word in the text for which further information is sought, communication of that identified specific word in the text to the processor commands a search for further information to be sought on that specific word, such that during that search, the processor simultaneously accesses multiple databases having information relating to the defined field of technology or literature, and each of the multiple databases responds to the accessing seeking further information on that specific word by providing file content from within the database containing that specific word, wherein file content is provided and visually displayed on the display containing uses of that specific word in a format comprising that specific word in combination with all single preceding word and each single subsequent word combinations of that specific word; and the provided word content is in the form of definition data structure that can be opened by the user through the user input.
